(19) United States
(12) Patent Application Publication
(10) Pub. No.: US 2026/0113779 A1
(43) Pub. Date: Apr. 23, 2026

(54) SECONDARY CELL DEACTIVATION BASED ON RANDOM ACCESS FAILURE

(71) Applicant: QUALCOMM Incorporated, San Diego, CA (US)

(72) Inventors: Sruthi RAM MOHAN, San Diego, CA (US); Madhup CHANDRA, San Diego, CA (US); Heechoon LEE, San Diego, CA (US); Sandeep RAMANNAVAR, San Diego, CA (US); Rohit BHASI THAZHATH, San Diego, CA (US); Brayan Alexis FERREL, San Diego, CA (US); Hemanth Kumar RAYAPATI, San Diego, CA (US)

(21) Appl. No.: 18/919,342

(22) Filed: Oct. 17, 2024

(51) Int. Cl. H04W 74/0833; H04W 52/36

(52) U.S. Cl. CPC H04W 74/0833; H04W 52/367

(57) ABSTRACT

Various aspects of the present disclosure generally relate to wireless communication. Some aspects more specifically relate to early secondary cell (SCell) deactivation in response to detecting a random access channel (RACH) failure. For example, the RACH failure may include, among other examples, the RACH occasion in which a user equipment (UE) transmits a RACH communication being outside of a network monitoring window; the UE or a network node not transmitting or receiving a RACH communication; the UE incorrectly applying a timing advance; or a physical downlink control channel (PDCCH) order including an incorrect preamble index. In response to the RACH failure, the UE may stop the timer that controls how long the UE considers the SCell to be uplink-time-aligned and deactivate the SCell.

### FIELD OF THE DISCLOSURE

Aspects of the present disclosure generally relate to wireless communication and specifically relate to techniques, apparatuses, and methods associated with secondary cell deactivation responsive to a random access failure.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples.

In carrier aggregation, a user equipment (UE) may be configured with multiple serving cells, such as a primary carrier or primary cell (PCell) and at least one secondary carrier or secondary cell (SCell). In some examples, the UE may start an uplink transmission early to compensate for propagation delays between the UE and a serving cell (for example, a PCell or an SCell). However, upon activation, an SCell may not be uplink-synchronized with a PCell, which can lead to decode errors and/or prevent transmission on the SCell. Accordingly, the UE may receive a physical downlink control channel (PDCCH) order that initiates a random access channel (RACH) procedure for uplink timing synchronization between the UE and a network node. In some examples, if a RACH failure occurs, the SCell may remain unsynchronized. However, the SCell may remain activated until expiration of a timer that controls how long the UE considers the SCell to be uplink-time-aligned. As a result, between the RACH failure and the expiration of the timer—when no data transfer on the SCell can occur—the UE allows RF hardware and firmware for SCell streaming to remain enabled, which can consume excessive power.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a random access initiation message associated with one or more of a primary cell (PCell) of the UE or one or more secondary cells (SCells) of the UE. At least one processor of the one or more processors may be configured to cause the UE to deactivate the one or more SCells responsive to a random access failure.

Some aspects described herein relate to a method of wireless communication performed at a UE. The method may include receiving a random access initiation message associated with one or more of a PCell of the UE or one or more SCells of the UE. The method may include deactivating the one or more SCells responsive to a random access failure.

Some aspects described herein relate to an apparatus for wireless communication. The apparatus may include means for receiving a random access initiation message associated with one or more of a PCell of the apparatus or one or more SCells of the apparatus. The apparatus may include means for deactivating the one or more SCells responsive to a random access failure.

Some aspects described herein relate to a non-transitory computer-readable medium storing a set of instructions for wireless communication. The set of instructions may include one or more instructions that, when executed at a UE, cause the UE to receive a random access initiation message associated with one or more of a PCell of the UE or one or more SCells of the UE. The set of instructions may include one or more instructions that, when executed at a UE, cause the UE to deactivate the one or more SCells responsive to a random access failure.

Some aspects described herein relate to an apparatus for wireless communication at a UE. The apparatus may include one or more memories storing processor-executable code and one or more processors coupled with the one or more memories. At least one processor of the one or more processors may be configured to cause the UE to identify one or more random access failure likelihood parameters. At least one processor of the one or more processors may be configured to cause the UE to identify, using a random access failure likelihood model and the one or more random access failure likelihood parameters, a likelihood of a predicted random access failure.

Some aspects described herein relate to a method of wireless communication performed at a UE. The method may include identifying one or more random access failure likelihood parameters. The method may include identifying, using a random access failure likelihood model and the one or more random access failure likelihood parameters, a likelihood of a predicted random access failure.

Some aspects described herein relate to an apparatus for wireless communication. The apparatus may include means for identifying one or more random access failure likelihood parameters. The apparatus may include means for identifying, using a random access failure likelihood model and the one or more random access failure likelihood parameters, a likelihood of a predicted random access failure.

Some aspects described herein relate to a non-transitory computer-readable medium storing a set of instructions for wireless communication. The set of instructions may include one or more instructions that, when executed at a UE, cause the UE to identify one or more random access failure likelihood parameters. The set of instructions may include one or more instructions that, when executed at a UE, cause the UE to identify, using a random access failure likelihood model and the one or more random access failure likelihood parameters, a likelihood of a predicted random access failure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example of a two-step random access procedure, in accordance with the present disclosure.

FIG. 4 is a diagram illustrating an example of a four-step random access procedure, in accordance with the present disclosure.

FIG. 5 is a diagram illustrating an example associated with uplink synchronization establishment, in accordance with the present disclosure.

FIG. 6 is a diagram illustrating an example associated with uplink synchronization establishment, in accordance with the present disclosure.

FIG. 7 is a diagram illustrating an example associated with signaling for secondary cell (SCell) deactivation based on a random access failure, in accordance with the present disclosure.

FIG. 8 is a diagram illustrating an example associated with random access failure prediction, in accordance with the present disclosure.

FIG. 9 is a diagram illustrating an example associated with a timeline for SCell deactivation based on random access failure, in accordance with the present disclosure.

FIG. 10 is a flowchart illustrating an example process performed, for example, at a UE or an apparatus of a UE that supports SCell deactivation responsive to random access failure in accordance with the present disclosure.

FIG. 11 is a flowchart illustrating an example process performed, for example, at a UE or an apparatus of a UE that supports SCell deactivation using a likelihood of a predicted random access failure in accordance with the present disclosure.

FIG. 12 is a diagram of an example apparatus for wireless communication that supports secondary cell deactivation responsive to random access failure in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may measure the timing of one or more uplink signals received from each connected user equipment (UE). For example, the uplink signals may include uplink data, such as an uplink signal carried on a physical uplink shared channel (PUSCH), carried on a physical uplink control channel (PUCCH), or comprising a sounding reference signal (SRS), among other examples. The network node may use the timing of the uplink signal(s) to estimate one or more uplink signal arrival times. The network node may, using the estimated arrival times, adjust the timing of any future uplink transmissions by identifying and transmitting uplink timing advance values to respective UEs. A UE may “advance” uplink transmissions to a serving cell of the network node using the uplink timing advance. For example, the UE may advance an uplink transmission (for example, the UE may start the uplink transmission early) to compensate for propagation delays between the UE and the serving cell.

Carrier aggregation is a technology that enables two or more component carriers (CCs, sometimes referred to as carriers) to be combined (for example, into a single channel) for a single UE to enhance data capacity. In carrier aggregation, a UE may be configured with a primary carrier or primary cell (PCell) and one or more secondary carriers or secondary cells (SCells). PCells and SCells are both serving cells of the UE. In carrier aggregation, the serving cells of the UE may belong to different timing advance groups (TAGs), where each TAG is associated with a given timing advance. Multi-TAG (mTAG) implementations may help to handle situations where multiple serving cells of the UE have different propagation delays.

In some examples, a physical downlink control channel (PDCCH) order may initiate a random access channel (RACH) procedure, which may help to synchronize uplink timing synchronization between the UE and the network node (for example, in scenarios where an SCell and a PCell are not uplink-synchronized). However, in the event of a RACH failure, the SCell may remain unsynchronized and in an activated state until a timer expires. As a result, the UE may consume excessive power by allowing SCell streaming to remain enabled between the RACH failure and the expiration of the timer, when no data transfer on the SCell can occur.

Various aspects relate generally to early SCell deactivation. Some aspects more specifically relate to triggering SCell deactivation in response to detecting a RACH failure. For example, the RACH failure may include, among other examples, the RACH occasion in which the UE transmits a RACH communication being outside of a network monitoring window; the UE or a network node not transmitting or receiving a RACH communication; the UE incorrectly applying a timing advance; or the PDCCH order including an incorrect preamble index. In response to the RACH failure, the UE may stop the timer that controls how long the UE considers the SCell to be uplink-time-aligned and deactivate the SCell.

In some aspects, the UE may predict the RACH failure. For example, the UE may use a likelihood model to identify a likelihood that a RACH failure will or will not occur. For example, the likelihood model may predict a likelihood that a given quantity of unsuccessful RACH attempts will occur. The likelihood model may evaluate parameters received in the PDCCH order (for example, a synchronization signal block (SSB) index, a RACH preamble index, or a RACH occasion index, among other examples) and/or other factors that can indicate a likelihood of RACH success.

In some aspects, the UE may deactivate the SCell in response to a deterministic RACH failure. For example, the UE may identify the deterministic RACH failure in response to detecting that a given quantity of unsuccessful RACH attempts has occurred.

Particular aspects of the subject matter described in this disclosure can be implemented to realize one or more of the following potential advantages. In some examples, by triggering SCell deactivation in response to detecting a RACH failure, the described techniques can be used to reduce power consumption at the UE. For example, early SCell deactivation may enable reduced power consumption for streaming and/or decoding during times when no data is expected.

Predicting the RACH failure may enable earlier SCell deactivation, thereby further reducing power consumption due to SCell streaming. For example, the predicted random access failure may enable the UE to deactivate an SCell before a RACH failure occurs.

Deactivating the deterministic RACH failure may help to reduce UE processing resources that would otherwise be occupied for prediction purposes.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, RF sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

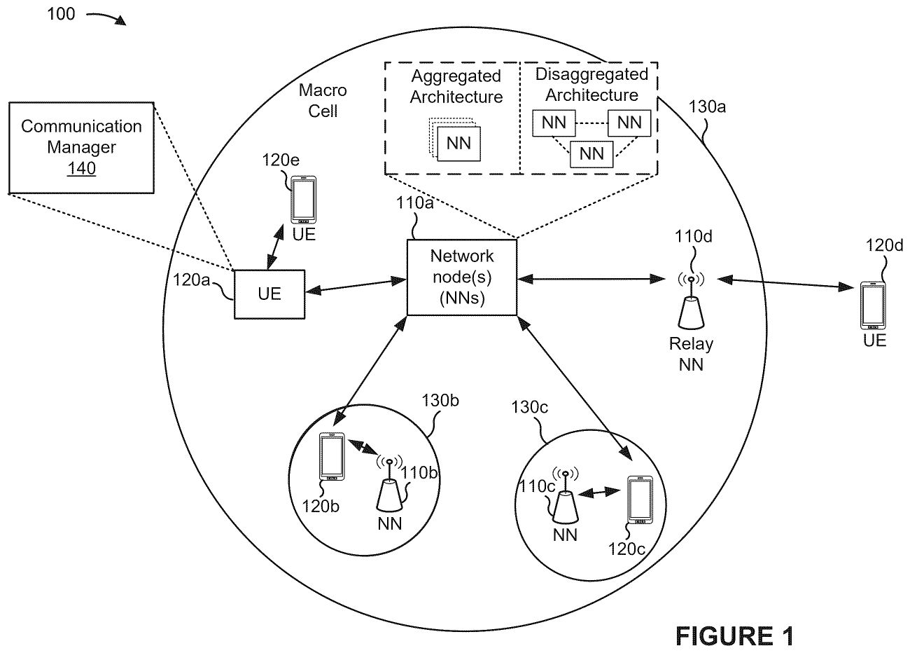

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHZ). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication.

In some aspects, the UE 120 may include a communication manager 140. As described in more detail elsewhere herein, the communication manager 140 may receive a random access initiation message associated with one or more of a PCell of the UE 120 or one or more SCells of the UE 120; and deactivate the one or more SCells responsive to a random access failure. Additionally or alternatively, the communication manager 140 may identify one or more random access failure likelihood parameters; and identify, using a random access failure likelihood model and the one or more random access failure likelihood parameters, a likelihood of a predicted random access failure. Additionally or alternatively, the communication manager 140 may perform one or more other operations described herein.

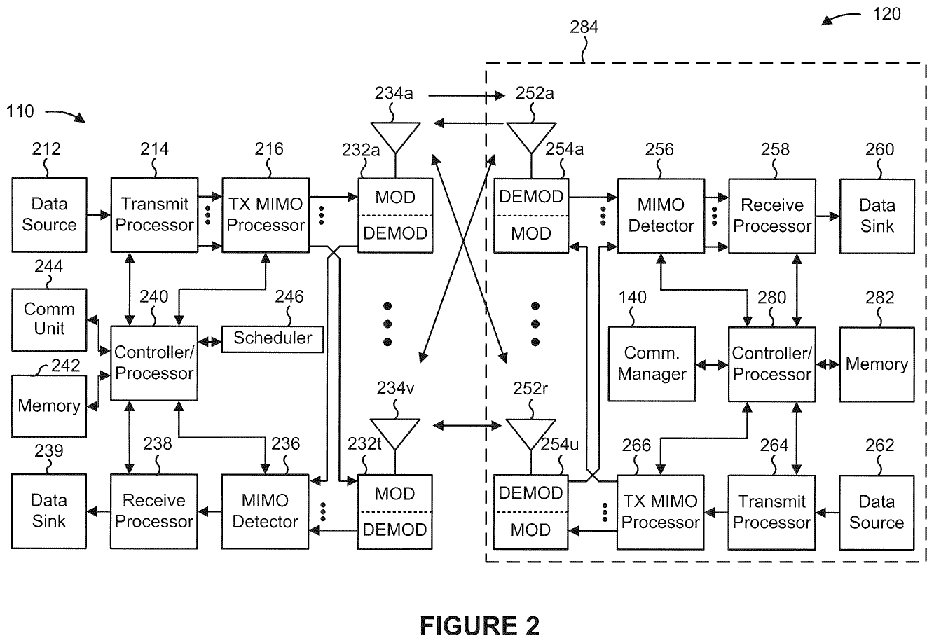

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244 and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a medium access control (MAC) control element (MAC-CE) communication, an RRC communication, or another type of uplink communication. Uplink signals may be transmitted on a physical PUSCH, a PUCCH, and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

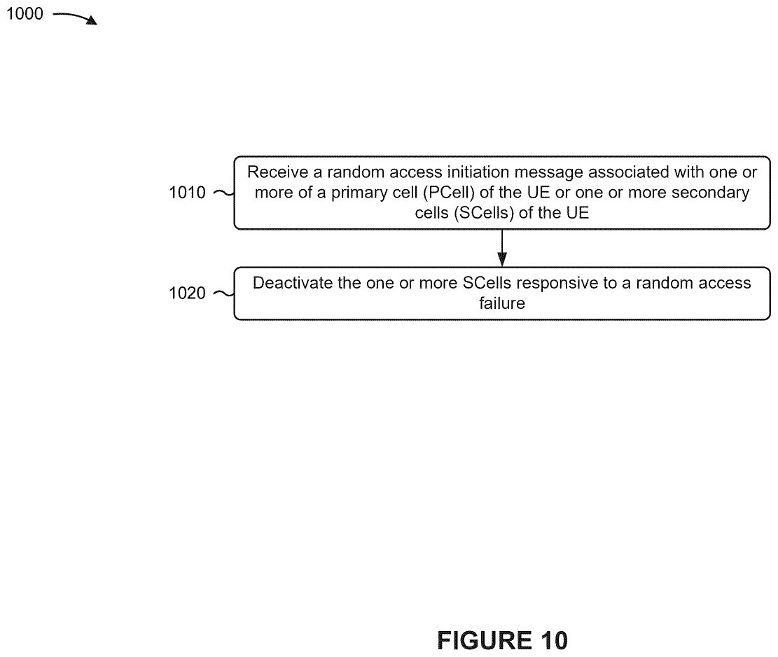

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with secondary cell deactivation responsive to random access failure, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 1000 of FIG. 10 (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving a random access initiation message associated with one or more of a PCell of the UE 120 or one or more SCells of the UE 120; and/or means for deactivating the one or more SCells responsive to a random access failure. In some aspects, the UE 120 includes means for identifying one or more random access failure likelihood parameters; and/or identifying, using a random access failure likelihood model and the one or more random access failure likelihood parameters, a likelihood of a predicted random access failure. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

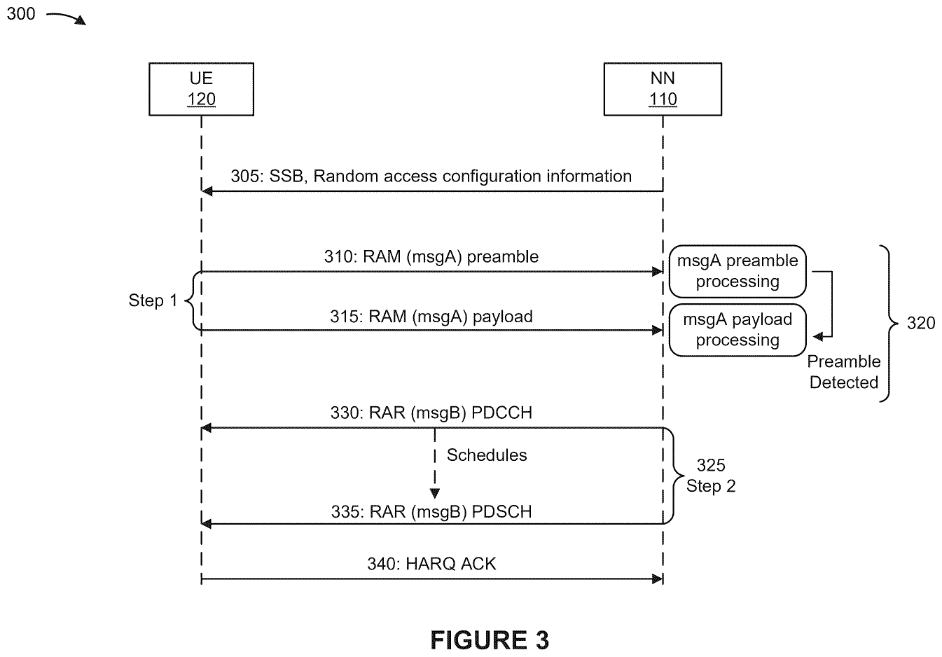

FIG. 3 is a diagram illustrating an example 300 of a two-step random access procedure, in accordance with the present disclosure. As shown in FIG. 3, a network node 110 and a UE 120 may communicate with one another to perform the two-step random access procedure.

In a first operation 305, the network node 110 may transmit, and the UE 120 may receive, one or more SSBs and random access configuration information. In some aspects, the random access configuration information may be transmitted in and/or indicated by system information (for example, in one or more system information blocks (SIBs)) and/or an SSB, such as for contention-based random access. Additionally or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

In a second operation 310, the UE 120 may transmit, and the network node 110 may receive, a RAM preamble. In a third operation 315, the UE 120 may transmit, and the network node 110 may receive, a RAM payload. As shown, the UE 120 May transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (for example, a PRACH preamble), and the RAM payload may include some or all contents of message 3 (for example, a UE identifier, uplink control information (UCI), and/or a physical uplink shared channel (PUSCH) transmission).

In a fourth operation 320, the network node 110 may receive the RAM preamble transmitted by the UE 120. If the network node 110 successfully receives and decodes the RAM preamble, the network node 110 may then receive and decode the RAM payload.

In a fifth operation 325, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

In a sixth operation 330, as part of the second step of the two-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation (for example, in DCI) for the PDSCH communication.

In a seventh operation 335, as part of the second step of the two-step random access procedure, the network node 110 may transmit the PDSCH communication for the RAR, as scheduled by the PDCCH communication. The RAR may be included in a medium access control (MAC) protocol data unit (PDU) of the PDSCH communication. In an eighth operation 340, if the UE 120 successfully receives the RAR, the UE 120 may transmit a hybrid automatic repeat request (HARQ) acknowledgement (ACK).

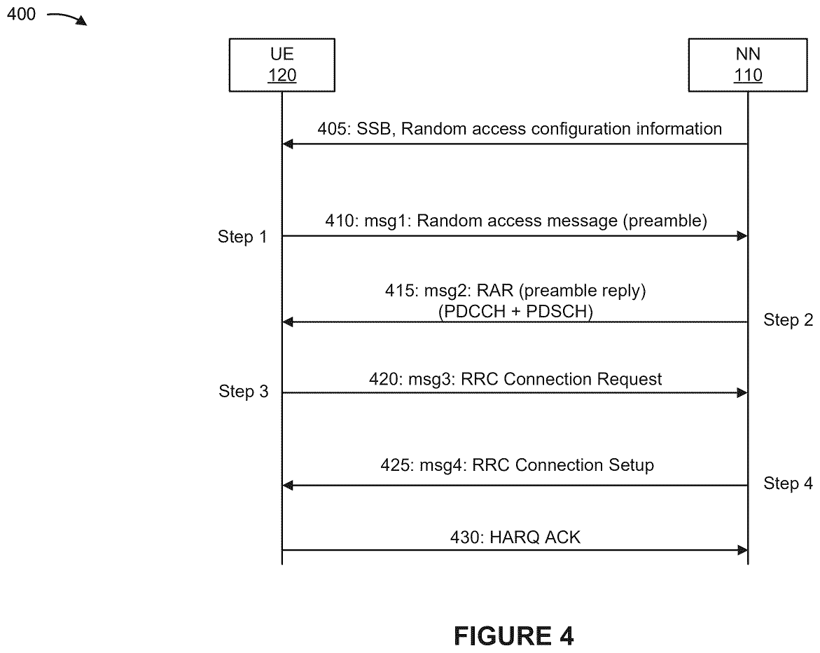

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

In a first operation 405, the network node 110 may transmit, and the UE 120 may receive, one or more SSBs and random access configuration information. In some aspects, the random access configuration information may be transmitted in and/or indicated by system information (for example, in one or more system information blocks (SIBs)) and/or an SSB, such as for contention-based random access. Additionally or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a RAM and/or one or more parameters for receiving an RAR.

In a second operation 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

In a third operation 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (for example, received from the UE 120 in msg1). Additionally or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR.

The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

In a fourth operation 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (for example, an RRC connection request).

In a fifth operation 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. In a sixth operation 430, if the UE 120 successfully receives the RRC connection setup message, the UE 120 may transmit a HARQ ACK.

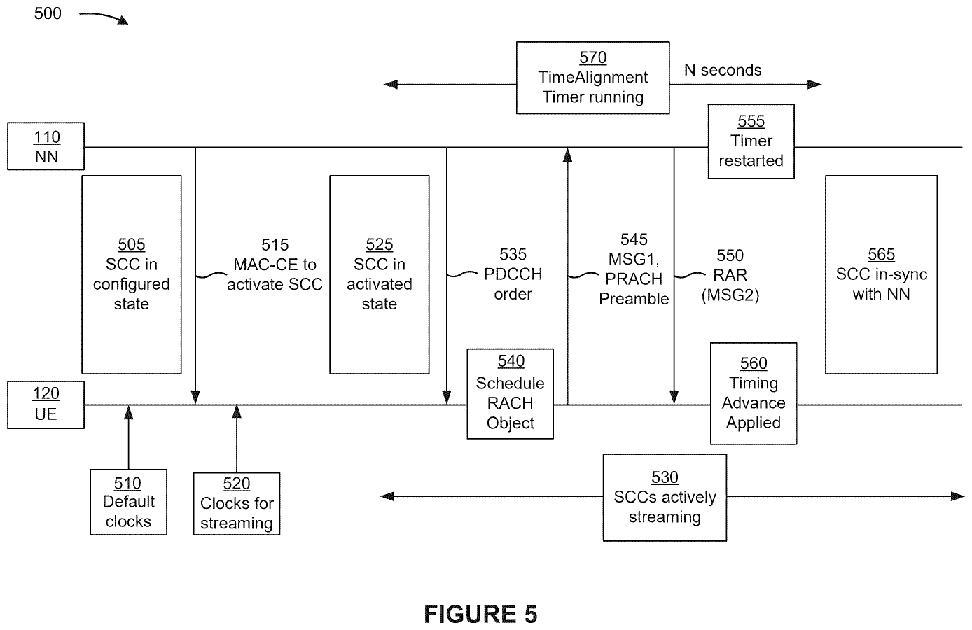

FIG. 5 is a diagram illustrating an example 500 associated with uplink synchronization establishment, in accordance with the present disclosure. As shown in FIG. 5, a network node 110 and a UE 120 may communicate with one another.

In carrier aggregation, the network node 110 may configure an SCell (or “secondary CC” or “SCC”). The configuration of the SCell may be referred to as SCell addition. In a first operation 505, the SCC may be in a configured state. In a second operation 510, one or more default clocks may be activated.

In a third operation 515, after the SCell addition is complete (for example, 3 ms after the SCell addition is complete), the network node 110 may transmit, and the UE 120 may receive, an activation request for the SCC (for example, a MAC-CE that activates the SCC). For example, an L1 layer at the UE 120 may receive the activation request. In a fourth operation 520, the UE 120 may activate one or more clocks for streaming on the SCell (for example, the UE 120 may adjust the default clock for carrier aggregation).

In a fifth operation 525, the SCC may enter an activated state. In some examples, the SCC may enter the activated state 6 ms after the UE 120 receives the MAC-CE. In a sixth operation 530, upon entering the activated state, the SCC may begin to actively stream. For example, the UE 120 may start streaming on the SCell using commands sent to baseband and/or RF components. For example, the UE 120 may use the SCell to transmit data and signals (for example, SRS or CSI reports, among other examples), monitor a PDCCH, or transmit PUCCH and/or uplink shared channel communications, among other examples.

Upon activation, the SCell may experience an uplink synchronization issue (for example, the SCC may be out-of-synchronization with the network node 110) that can lead to decode errors and/or prevent transmission on the SCell. For example, in mTAG, the Scell may not be co-located with the PCell, which can cause different propagation delays inherent to transmissions. Additionally or alternatively, in carrier aggregation scenarios involving FR1 and FR2 (for example, where a first aggregated cell is associated with FR1 and a second aggregated cell is associated with FR2), different channel propagation characteristics can compound different propagation delays, particularly for SCCs associated with FR2.

Such uplink synchronization issues may be mitigated with a PDCCH order (for example, a PDCCH order RACH communication), which can synchronize the uplink timing between the UE 120 and the network node 110. In a seventh operation 535, the network node 110 may transmit, and the UE 120 may receive, a PDCCH order RACH communication. In some examples, the network node 110 may trigger the PDCCH order RACH communication by transmitting DCI with format 1_0, with a PRACH preamble and a RACH occasion, on an SSB beam index on which the UE 120 is camped. In some examples, a MAC entity of the UE 120 may receive the PDCCH order RACH communication.

In an eighth operation 540, upon receiving the PDCCH order RACH communication, the UE 120 may schedule one or more RACH objects for transmission (for example, one or more RACH communications that are part of a RACH procedure). In a ninth operation 545, the UE 120 may initiate the RACH procedure. For example, the UE 120 may transmit, and the network node 110 may receive, the PRACH preamble and a MSG1 on the SCell targeted by the PDCCH order. In a tenth operation 550, the network node 110 may transmit, and the UE 120 may receive, a MSG2 on the PCell. For example, the MSG2 may include an RAR that is transmitted and received using a random access radio network temporary identifier (RA-RNTI) in a common search space. The RAR may include a timing advance command and/or a grant that is valid for the SCell on which the PRACH preamble was transmitted.

In an eleventh operation 555, after transmitting the RAR, the network node 110 may restart a timer (for example, a TimeAlignmentTimer) associated with a secondary TAG (sTAG) to which the SCell belongs. The timer may control how long the UE 120 considers the SCell belonging to the sTAG to be uplink time aligned. In a twelfth operation 560, after receiving the RAR, the UE 120 may apply the timing advance command in the RAR to the sTAG. The UE 120 may also start (or restart) the timer after receiving the RAR. In a thirteenth operation 565, the SCC may thereafter be synchronized with the network node 110.

In a fourteenth operation 570, the timer may start to run when the SCC enters the activated state, and continue to run for N seconds. For example, N may have a maximum finite value of 10,240 ms and a default value of infinity. A section of a TAG configuration with example timer values is provided as follows:

| | |
|---|---|
| TAG-Config ::= | SEQUENCE { |
| tag-ToReleaseList | SEQUENCE (SIZE (1..maxNrofTAGs)) OF TAG- |

Id OPTIONAL,-- Need N

| | |
|---|---|
| tag-ToAddModList | SEQUENCE (SIZE (1..maxNrofTAGs)) OF TAG- |

ToAddMod OPTIONAL -- Need N
}

| | |
|---|---|
| TAG-ToAddMod ::= | SEQUENCE { |
| tag-Id | TAG-Id, |
| timeAlignmentTimer | TimeAlignmentTimer, |

...
}

| | |
|---|---|
| TAG-Id ::= | INTEGER (0..maxNrofTAGs-1) |
| TimeAlignmentTimer ::= | ENUMERATED {ms500, ms750, ms1280, ms1920, |

ms2560, ms5120, ms10240, infinity}

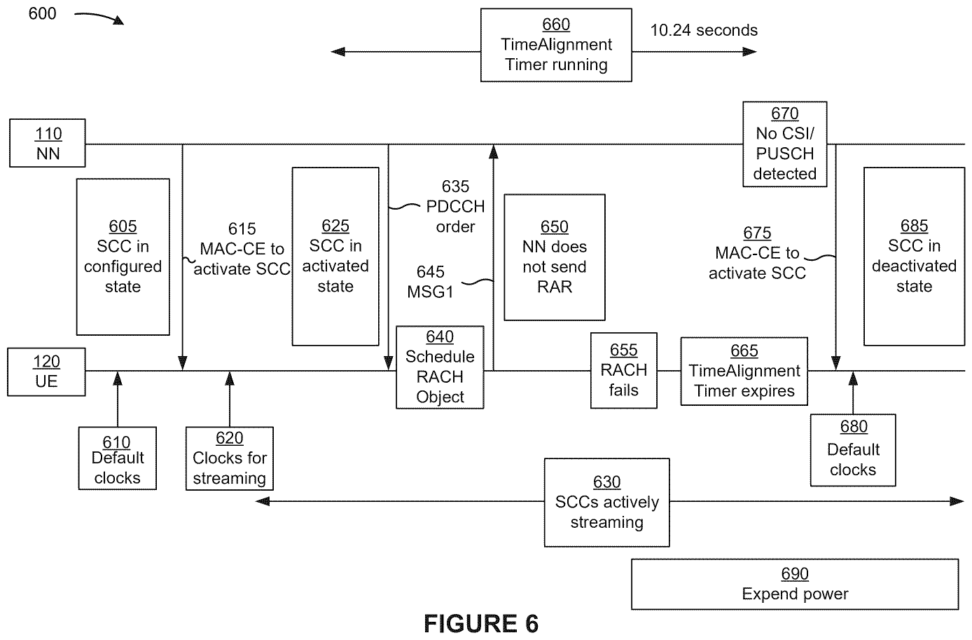

FIG. 6 is a diagram illustrating an example 600 associated with uplink synchronization establishment, in accordance with the present disclosure. As shown in FIG. 6, a network node 110 and a UE 120 may communicate with one another.

In a first operation 605, the SCC may be in configured state. In a second operation 610, one or more default clocks may be activated. In a third operation 615, after the SCell addition is complete (for example, 3 ms after the SCell addition is complete), the network node 110 may transmit, and the UE 120 may receive, an activation request for the SCC (for example, a MAC-CE that activates the SCC). For example, an L1 layer at the UE 120 may receive the activation request. In a fourth operation 620, the UE 120 may activate one or more clocks for streaming on the SCell (for example, the UE 120 may adjust the default clock for carrier aggregation).

In a fifth operation 625, the SCC may enter an activated state. In some examples, the SCC may enter the activated state 6 ms after the UE 120 receives the MAC-CE. In a sixth operation 630, upon entering the activated state, the SCC may begin to actively stream. For example, the UE 120 may start streaming on the SCell using commands sent to baseband and/or RF components. For example, the UE 120 may use the SCell to transmit data and signals (for example, SRS or CSI reports, among other examples), monitor a PDCCH, or transmit PUCCH and/or uplink shared channel communications, among other examples.

In a seventh operation 635, the network node 110 may transmit, and the UE 120 may receive, a PDCCH order RACH communication. In some examples, the network node 110 may trigger the PDCCH order RACH communication by transmitting DCI with format 1_0, with a PRACH preamble and a RACH occasion, on an SSB beam index on which the UE 120 is camped. In some examples, a MAC entity of the UE 120 may receive the PDCCH order RACH communication.

In an eighth operation 640, upon receiving the PDCCH order RACH communication, the UE 120 may schedule one or more RACH objects for transmission (for example, one or more RACH communications that are part of a RACH procedure). In a ninth operation 645, the UE 120 may initiate the RACH procedure. For example, the UE 120 may transmit, and the network node 110 may receive, a MSG1 on the SCell targeted by the PDCCH order.

The UE 120 may receive the PDCCH order for the activated Scell and initiate the RACH procedure, but the RACH procedure may fail for various reasons. In some examples, the RACH occasion in which the UE 120 transmits the MSG1 may be outside of a network monitoring window. In some examples, the MSG1 transmission may fail to reach the network node 110. In such examples, in a tenth operation 650, the network node 110 may not transmit an RAR. In some examples, the network node 110 May transmit, but the UE 120 may not receive, an RAR. In some examples, a MSG3 (for transmit scheduling) may fail to reach the network node 110 or the timing advance may be incorrectly applied at the UE 120. In some examples, an incorrect preamble index may be provided in the PDCCH order.

In any event, in an eleventh operation 655, the RACH procedure may fail. RACH failure may commonly occur in areas where carrier aggregation involving FR1 and FR2 is deployed. RACH failure can occur repeatedly in poor coverage and high contention areas, triggering multiple RACH attempts. Thus, uplink synchronization may not occur.

In a twelfth operation 660, a timer (for example, a TimeAlignmentTimer associated with the SCell) may start to run when the SCC enters the activated state and continue to run for N seconds (where N may be a non-integer quantity of seconds, such as 10.24 seconds). In a thirteenth operation 665, the time may expire. For example, upon stopping uplink transmissions for an SCell because a maximum uplink transmission timing difference between different TAGs of a MAC entity is exceeded, the MAC entity of the UE 120 may consider the timer to be expired.

In dual PUCCH group configurations, when the timer is expired, the UE 120 may flush all HARQ buffers for all of the serving cells belonging to the sTAG, and notify an RRC layer to release any SRSs for all serving cells belonging to the sTAG. Thus, in a fourteenth operation 670, the network node 110 may receive no PUSCH, PUCCH, or CSI communications (for example, RSRP reports). As a result, the network node 110 may be unable to estimate uplink signal arrival times, and, in a fifteenth operation 675, the network node 110 may deactivate (for example, deconfigure) the SCC after a given timer window. In a sixteenth operation 680, the UE 120 may resume use of the default clocks, and in a seventeenth operation 685, the SCC may enter a deactivated state.

In the sixth operation 630, streaming may remain enabled at the UE 120 during a time window that extends from the time of the RACH failure until the SCC enters the deactivated state. This time window may persist for extended periods of time (for example, up to 10,240 ms). During this time window, the UE 120 may enable RF hardware and firmware for the SCC. In an eighteenth operation 690, the UE 120 may expend excessive power (for example, drain a battery of the UE 120) by leaving the SCC streaming enabled after the RACH failure, when no data transfer on the SCC can occur.

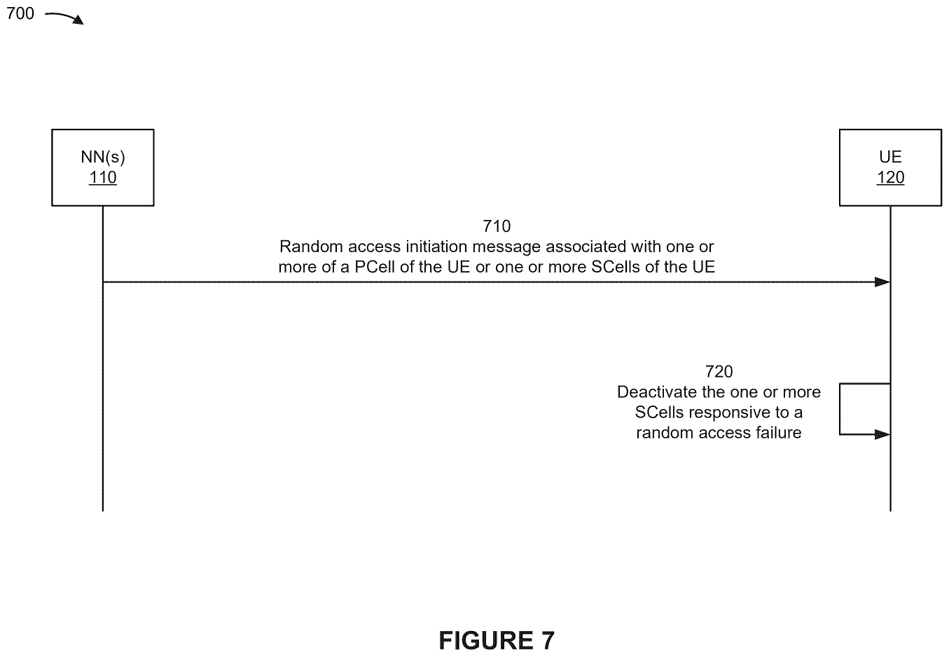

FIG. 7 is a diagram illustrating an example 700 associated with signaling for SCell deactivation based on a random access failure, in accordance with the present disclosure. As shown in FIG. 7, a network node 110 and a UE 120 may communicate with one another.

In a first operation 710, the network node 110 may transmit, and the UE 120 may receive, a random access initiation message associated with one or more of a PCell of the UE 120 or one or more SCells of the UE 120. The random access initiation message may initiate a random access procedure (for example, a two-step random access procedure as discussed above in connection with FIG. 3 or a four-step random access procedure as discussed above in connection with FIG. 4, among other examples). In some examples, the random access initiation message may be a PDCCH order, as discussed above in connection with the seventh operation 535 (FIG. 5) and the seventh operation 635 (FIG. 6). The random access initiation message may be associated with the PCell and/or the SCell(s) in that the random access initiation message may initiate a random access procedure that involves messages communicated with the PCell and/or the SCell(s). For example, a MSG1 of the random access procedure may be transmitted on the SCell(s) and/or the MSG2 may be received by the PCell.

In a second operation 720, the UE 120 may deactivate (for example, de-configure) the one or more SCells responsive to a random access failure. The random access failure may be a failure of the random access procedure initiated by the random access initiation message. For example, the random access failure may include a PDCCH order RACH failure or a UE synchronization failure, among other examples. In some aspects, an L1 controller (for example, an L1 controller module) of the UE 120 may deactivate the one or more SCells responsive to obtaining an SCell failure status indication from a MAC controller (for example, a MAC module) of the UE 120. For example, the MAC module may trigger the SCell deactivation (for example, CC deactivation) by indicating the SCell failure status (for example, an indication of the random access failure for the SCell) to the lower layers, and, in response, the L1 controller may perform the SCell deactivation. In some aspects, the L1 controller may disable RF hardware or firmware streaming on the SCell. For example, the L1 controller may disable streaming for the RF hardware and firmware.

In some aspects, the random access failure may include a deterministic (for example, an actual) random access failure. The deterministic random access failure may include the network node 110 not receiving the MSG1 or the UE 120 not receiving the MSG2, among other examples (for example, as discussed above in connection with FIG. 6). In some examples, the UE 120 may detect the deterministic random access failure.

In some aspects, the deterministic random access failure may include a quantity of random access attempts satisfying a random access attempt threshold. For example, the UE 120 may detect the deterministic random access failure by identifying that the quantity of random access attempts has satisfied (for example, exceeded) the random access attempt threshold (for example, a PUSCH occasion (PO) RACH failure has occurred after X attempts). The random access attempt threshold may be a maximum quantity of random access attempts.

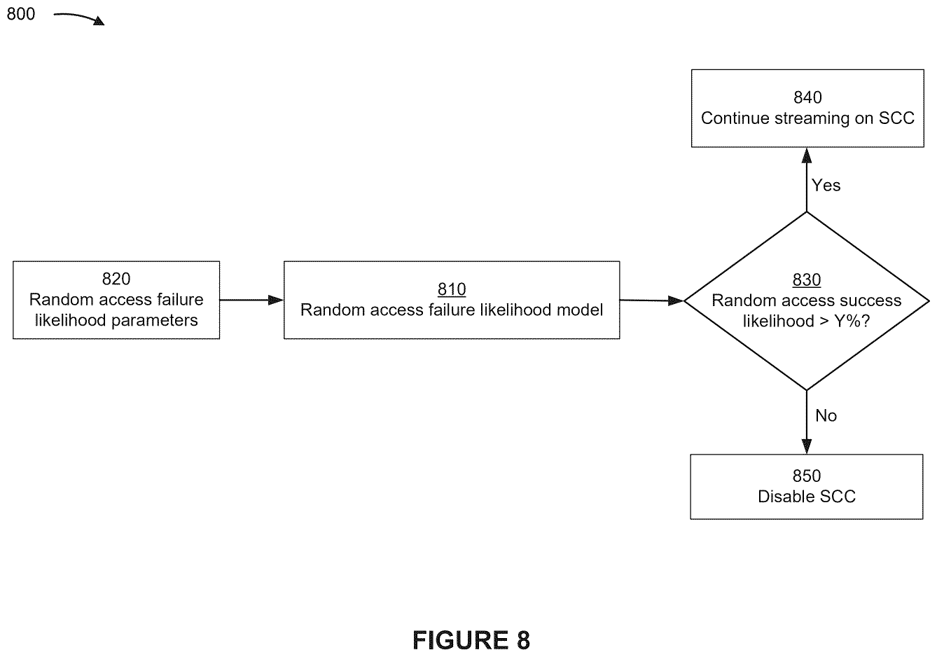

FIG. 8 is a diagram illustrating an example 800 associated with random access failure prediction, in accordance with the present disclosure.

In some aspects, the random access failure may include a predicted random access failure. The predicted random access failure may include a prediction of a random access failure (for example, as discussed above in connection with FIG. 7) and/or a possibility of a random access failure. In some examples, the UE 120 may predict a possibility that a quantity of random access attempts will satisfy (for example, exceed) a random access attempt threshold (for example, a PO RACH failure will occur after X attempts).

In some aspects, the predicted random access failure may be associated with a random access failure likelihood model 810. The predicted random access failure may be associated with the random access failure likelihood model 810 in that the predicted random access failure may be predicted using the random access failure likelihood model 810. In some examples, the random access failure likelihood model 810 may comprise a cache-based history of cell RSRP and/or transmit power, a crowd-sourcing-based model, or a machine learning model, among other examples.

In some aspects, the predicted random access failure may be associated with one or more random access failure likelihood parameters 820. The predicted random access failure may be associated with the one or more random access failure likelihood parameters 820 in that the predicted random access failure may be predicted using the one or more random access failure likelihood parameters 820 (for example, factors). For example, the one or more random access failure likelihood parameters 820 may be inputs to the random access failure likelihood model 810. In some examples, the one or more random access failure likelihood parameters 820 may be associated with (for example, predictive of) random access success. For example, the random access failure likelihood model 810 may evaluate one or more success rates (for example, random access procedure success rates) associated with the one or more random access failure likelihood parameters 820. In some aspects, the UE 120 may identify the one or more random access failure likelihood parameters 820. For example, as discussed below, the UE 120 may identify the one or more random access failure likelihood parameters 820 from one or more received communications (for example, the random access initiation message), by internally tracking the one or more random access failure likelihood parameters 820, or the like.

In some aspects, the one or more random access failure likelihood parameters 820 may include an SSB index. In some examples, the UE 120 may receive the SSB index in the random access initiation message.

In some aspects, the one or more random access failure likelihood parameters may include a random access preamble index. For example, the random access preamble index may correspond to a preamble format. In some examples, the UE 120 may receive the random access preamble index in the random access initiation message.

In some aspects, the one or more random access failure likelihood parameters may include a random access occasion index. The random access occasion index may correspond to a given random access occasion (for example, a RACH occasion). In some examples, the UE 120 may receive the random access occasion index in the random access initiation message.

In some aspects, the one or more random access failure likelihood parameters may include a random access message transmit power. For example, the random access message transmit power may comprise a MSG1 transmit power.

In some aspects, the one or more random access failure likelihood parameters may include a quantity of random access attempts relative to a random access attempt threshold. For example, the UE 120 may track the quantity of random access attempts that have been made (for example, by maintaining a PO RACH attempt count) and identify a quantity of remaining random access attempts until the quantity of random access attempts reaches the random access attempt threshold. The UE 120 may withdraw from the random access procedure before reaching the random access attempt threshold, which may be a maximum quantity of random access attempts.

In some aspects, the one or more random access failure likelihood parameters may include a received signal strength associated with a serving cell of the UE. The received signal strength may be associated with the serving cell in that the received signal strength may measure a strength of a signal received from the serving cell. For example, the received signal strength may be an FR2 serving cell measurement.

In some aspects, the one or more random access failure likelihood parameters may include one or more of a power class of the UE 120 or a maximum transmit power of the UE 120. The maximum transmit power may be a maximum amount of power that the UE 120 is capable of using to transmit a wireless communication. In some examples, the power class may indicate the maximum transmit power.

In some aspects, the UE 120 may identify a likelihood of the predicted random access failure using the random access failure likelihood model 810 and the one or more random access failure likelihood parameters 820. For example, the random access failure likelihood model may take, as input, the one or more random access failure likelihood parameters 820, and output the likelihood of the predicted random access failure. In some aspects, the UE 120 may deactivate the one or more SCells in accordance with the likelihood of the predicted random access failure. In some aspects, the UE 120 may deactivate the one or more SCells in accordance with the likelihood of the predicted random access failure satisfying a random access failure likelihood threshold. For example, in a first operation 830, the UE 120 may identify whether a likelihood of a predicted random access success is greater than a random access success likelihood threshold (for example, Y %). The UE 120 identifying whether the likelihood of the predicted random access success satisfies (for example, is greater than) the random access failure likelihood threshold may be equivalent to the UE 120 identifying whether the likelihood of the predicted random access failure satisfies (for example, is less than) a random access failure likelihood threshold. For example, a sum of the likelihood of the predicted random access success and the likelihood of the predicted random access failure may be 1, and a sum of the random access success likelihood threshold and the random access failure likelihood threshold may be 1. In some examples, the likelihood of the predicted random access success may comprise a PO RACH success likelihood.

In a second operation 840, if the likelihood of the predicted random access success is greater than Y %, then the UE 120 may continue streaming on the SCC. In a third operation 850, if the likelihood of the predicted random access success is less than or equal to Y %, then the UE 120 may disable the SCC (for example, the UE 120 may implicitly disable streaming on the SCC).

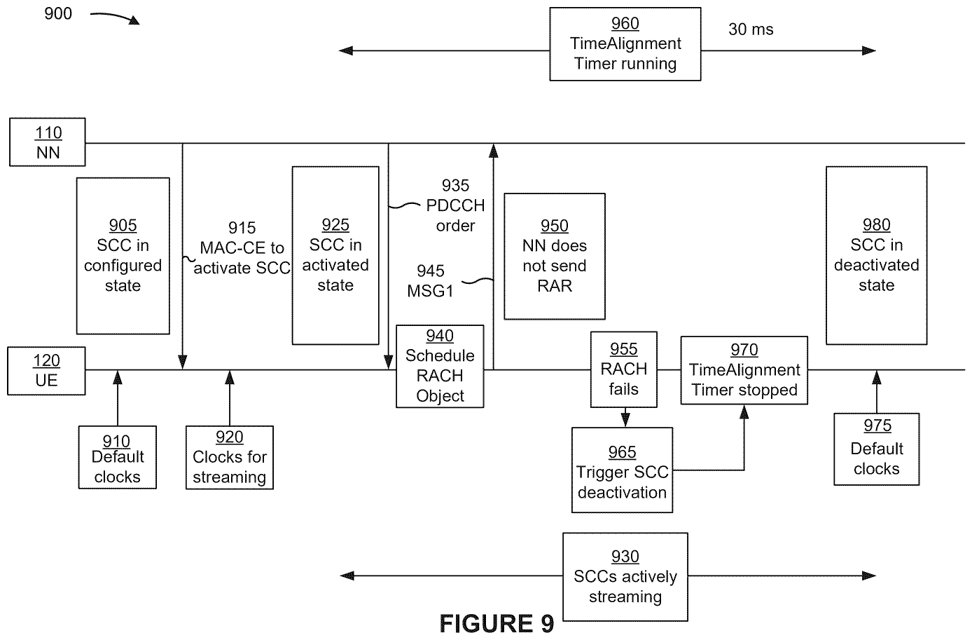

FIG. 9 is a diagram illustrating an example 900 associated with a timeline for SCell deactivation based on random access failure, in accordance with the present disclosure.

In a first operation 905, the SCC may be in configured state. In a second operation 910, one or more default clocks may be activated. In a third operation 915, after the SCell addition is complete (for example, 3 ms after the SCell addition is complete), the network node 110 may transmit, and the UE 120 may receive, an activation request for the SCC (for example, a MAC-CE that activates the SCC). For example, an L1 layer at the UE 120 may receive the activation request. In a fourth operation 920, the UE 120 may activate one or more clocks for streaming on the SCell (for example, the UE 120 may adjust the default clock for carrier aggregation).

In a fifth operation 925, the SCC may enter an activated state. In some examples, the SCC may enter the activated state 6 ms after the UE 120 receives the MAC-CE. In a sixth operation 930, upon entering the activated state, the SCC may begin to actively stream. For example, the UE 120 may start streaming on the SCell using commands sent to baseband and/or RF components. For example, the UE 120 may use the SCell to transmit data and signals (for example, SRS or CSI reports, among other examples), monitor a PDCCH, or transmit PUCCH and/or uplink shared channel communications, among other examples.

In a seventh operation 935, the network node 110 may transmit, and the UE 120 may receive, a PDCCH order RACH communication. In some examples, the network node 110 may trigger the PDCCH order RACH communication by transmitting DCI with format 1_0, with a PRACH preamble and a RACH occasion, on an SSB beam index on which the UE 120 is camped. In some examples, a MAC entity of the UE 120 may receive the PDCCH order RACH communication.

In an eighth operation 940, upon receiving the PDCCH order RACH communication, the UE 120 may schedule one or more RACH objects for transmission (for example, one or more RACH communications that are part of a RACH procedure). In a ninth operation 945, the UE 120 may initiate the RACH procedure. For example, the UE 120 may transmit, and the network node 110 may receive, a MSG1 on the SCell targeted by the PDCCH order. In a tenth operation 950, the network node 110 may not transmit an RAR.

In an eleventh operation 955, the RACH procedure may fail. Thus, uplink synchronization may not occur. In a twelfth operation 960, a timer (for example, a TimeAlignmentTimer associated with the SCell) may start to run when the SCC enters the activated state. In a thirteenth operation 965, the UE 120 may trigger deactivation of the SCC. In a fourteenth operation 970, the timer may stop. In a fifteenth operation 975, the UE 120 may resume use of the default clocks, and in a sixteenth operation 980, the SCC may enter a deactivated state.

In the sixth operation 930, streaming may remain enabled at the UE 120 during a time window that extends from the time of the RACH failure until the SCC enters the deactivated state, at which time the UE 120 may cease consuming power to leave the SCC streaming enabled. This time window may persist for periods of time that are less than the periods of time discussed above in connection with the sixth operation 630 (FIG. 6). For example, this time window may be 30 ms instead of 10,240 ms.

Thus, deactivating the one or more SCells responsive to the random access failure may help to reduce an overall timeline for SCell deactivation, thereby enabling enhanced power optimization, earlier failure recovery, and decreased performance degradation. For example, early SCell deactivation may enable reduced power consumption for streaming and/or decoding during times when no data is expected. In some examples, the deactivation process may take approximately 10 ms, which is a reduction of approximately 9.5 seconds in overall streaming time in a worst-case scenario for TimeAlignment timer expiration. As a result, by pre-emptively triggering UE internal SCell deactivation, the UE 120 may avoid situations where SCell power drain continues until the network node 110 deactivates the SCC(s). In some examples, the UE 120 may achieve power optimization through PO failure detection for mTAG and/or carrier aggregation involving FR1 and FR2. In some examples, the UE 120 may use a graceful exit mechanism with minimal involvement of upper layers in the protocol stack. In some examples, the UE 120 may log and/or note a reason for the failure, which can help to ensure successful uplink alignment for future SCell activation and/or PDCCH order attempts (for example, the UE 120 may mitigate or prevent PDCCH order RACH failures).

Deactivating the one or more SCells in accordance with the likelihood of the predicted random access failure may enable earlier SCell deactivation, thereby further reducing power consumption due to SCell streaming. For example, the predicted random access failure may enable the UE 120 to provide possible streaming optimizations before an unsuccessful RACH outcome.

The deterministic random access failure may help to reduce UE processing resources that would otherwise be occupied for prediction purposes.

FIG. 10 is a flowchart illustrating an example process 1000 performed, for example, at a UE or an apparatus of a UE that supports SCell deactivation responsive to random access failure in accordance with the present disclosure. Example process 1000 is an example where the apparatus or the UE (for example, UE 120) performs operations associated with SCell deactivation responsive to random access failure.

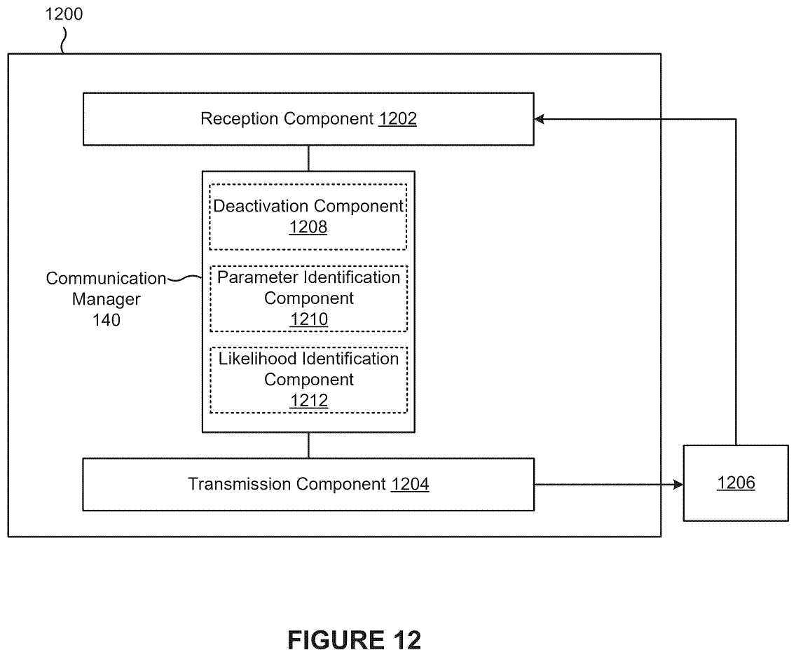

As shown in FIG. 10, in some aspects, process 1000 may include receiving a random access initiation message associated with one or more of a PCell of the UE or one or more SCells of the UE (block 1010). For example, the UE (such as by using communication manager 140 or reception component 1202, depicted in FIG. 12) may receive a random access initiation message associated with one or more of a PCell of the UE or one or more SCells of the UE, as described above.

As further shown in FIG. 10, in some aspects, process 1000 may include deactivating the one or more SCells responsive to a random access failure (block 1020). For example, the UE (such as by using communication manager 140 or deactivation component 1208, depicted in FIG. 12) may deactivate the one or more SCells responsive to a random access failure, as described above.

Process 1000 may include additional aspects, such as any single aspect or any combination of aspects described below or in connection with one or more other processes described elsewhere herein.

In a first additional aspect, the random access failure comprises a predicted random access failure.

In a second additional aspect, alone or in combination with the first aspect, the predicted random access failure is associated with a random access failure likelihood model.

In a third additional aspect, alone or in combination with one or more of the first and second aspects, the predicted random access failure is associated with one or more random access failure likelihood parameters.

In a fourth additional aspect, alone or in combination with one or more of the first through third aspects, the one or more random access failure likelihood parameters include an SSB index.

In a fifth additional aspect, alone or in combination with one or more of the first through fourth aspects, the one or more random access failure likelihood parameters include a random access preamble index.

In a sixth additional aspect, alone or in combination with one or more of the first through fifth aspects, the one or more random access failure likelihood parameters include a random access occasion index.

In a seventh additional aspect, alone or in combination with one or more of the first through sixth aspects, the one or more random access failure likelihood parameters include a random access message transmit power.

In an eighth additional aspect, alone or in combination with one or more of the first through seventh aspects, the one or more random access failure likelihood parameters include a quantity of random access attempts relative to a random access attempt threshold.

In a ninth additional aspect, alone or in combination with one or more of the first through eighth aspects, the one or more random access failure likelihood parameters include a received signal strength associated with a serving cell of the UE.

In a tenth additional aspect, alone or in combination with one or more of the first through ninth aspects, the one or more random access failure likelihood parameters include one or more of a power class of the UE or a maximum transmit power of the UE.

In an eleventh additional aspect, alone or in combination with one or more of the first through tenth aspects, deactivating the one or more SCells includes deactivating the one or more SCells in accordance with a likelihood of the predicted random access failure satisfying a random access failure likelihood threshold.

In a twelfth additional aspect, alone or in combination with one or more of the first through eleventh aspects, the random access failure comprises a deterministic random access failure.

In a thirteenth additional aspect, alone or in combination with one or more of the first through twelfth aspects, the deterministic random access failure comprises a quantity of random access attempts satisfying a random access attempt threshold.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

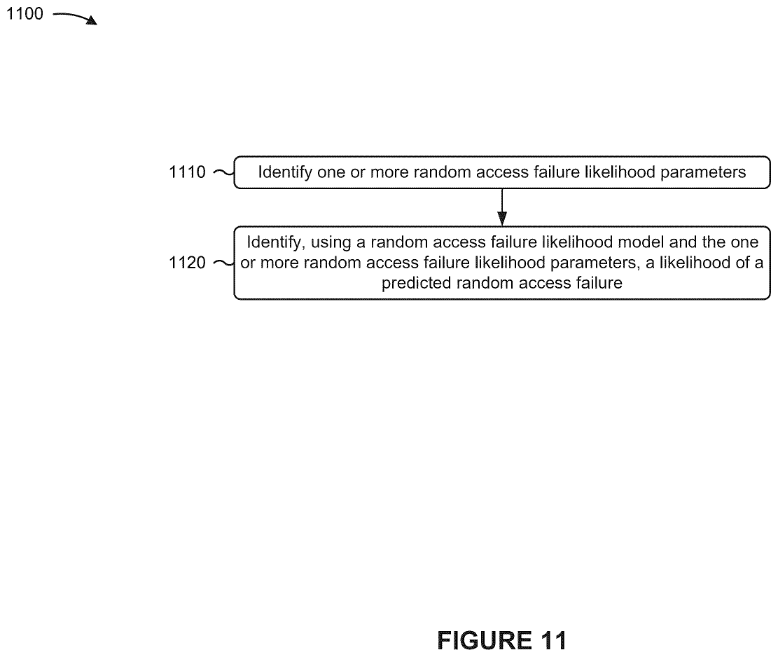

FIG. 11 is a flowchart illustrating an example process 1100 performed, for example, at a UE or an apparatus of a UE that supports SCell deactivation using a likelihood of a predicted random access failure in accordance with the present disclosure. Example process 1100 is an example where the apparatus or the UE (for example, UE 120) performs operations associated with SCell deactivation using a likelihood of a predicted random access failure.

As shown in FIG. 11, in some aspects, process 1100 may include identifying one or more random access failure likelihood parameters (block 1110). For example, the UE (such as by using communication manager 140 or parameter identification component 1210, depicted in FIG. 12) may identify one or more random access failure likelihood parameters, as described above.

As further shown in FIG. 11, in some aspects, process 1100 may include identifying, using a random access failure likelihood model and the one or more random access failure likelihood parameters, a likelihood of a predicted random access failure (block 1120). For example, the UE (such as by using communication manager 140 or likelihood identification component 1212, depicted in FIG. 12) may identify, using a random access failure likelihood model and the one or more random access failure likelihood parameters, a likelihood of a predicted random access failure, as described above.

Process 1100 may include additional aspects, such as any single aspect or any combination of aspects described below or in connection with one or more other processes described elsewhere herein.

In a first additional aspect, the one or more random access failure likelihood parameters include one or more of an SSB index, a quantity of random access attempts relative to a random access attempt threshold, a received signal strength associated with a serving cell of the UE, a power class of the UE, or a maximum transmit power of the UE.

In a second additional aspect, alone or in combination with the first aspect, the one or more random access failure likelihood parameters include a random access preamble index.

In a third additional aspect, alone or in combination with one or more of the first and second aspects, the one or more random access failure likelihood parameters include a random access occasion index.

In a fourth additional aspect, alone or in combination with one or more of the first through third aspects, the one or more random access failure likelihood parameters include a random access message transmit power.

In a fifth additional aspect, alone or in combination with one or more of the first through fourth aspects, process 1100 may include deactivating one or more SCells in accordance with the likelihood of the predicted random access failure.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports SCell deactivation responsive to random access failure in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 7-9. Additionally or alternatively, the apparatus 1200 may be configured to and/or operable to perform one or more processes described herein, such as process 1000 of FIG. 10. In some aspects, the apparatus 1200 may include one or more components of the UE described above in connection with FIG. 1 and FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 1204 may be co-located with the reception component 1202 in one or more transceivers.

The communication manager 140 may receive or may cause the reception component 1202 to receive a random access initiation message associated with one or more of a PCell of the UE or one or more SCells of the UE. The communication manager 140 may deactivate the one or more SCells responsive to a random access failure. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 1 and FIG. 2. In some aspects, the communication manager 140 includes a set of components, such as a deactivation component 1208, a parameter identification component 1210, and/or a likelihood identification component 1212. Alternatively, the set of components may be separate and distinct from the communication manager 140. In some aspects, one or more components of the set of components may include or may be implemented within one or more controllers/processors and/or one or more memories of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

In some aspects, the reception component 1202 may receive a random access initiation message associated with one or more of a PCell of the UE or one or more SCells of the UE; and/or the deactivation component 1208 may deactivate the one or more SCells responsive to a random access failure. In some aspects, the parameter identification component 1210 may identify one or more random access failure likelihood parameters; the likelihood identification component 1212 may identify, using a random access failure likelihood model and the one or more random access failure likelihood parameters, a likelihood of a predicted random access failure; and/or the deactivation component 1208 may deactivate the one or more SCells in accordance with the likelihood of the predicted random access failure.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a user equipment (UE), comprising: receiving a random access initiation message associated with one or more of a primary cell (PCell) of the UE or one or more secondary cells (SCells) of the UE; and deactivating the one or more SCells responsive to a random access failure.

Aspect 2: The method of Aspect 1, wherein the random access failure comprises a predicted random access failure.

Aspect 3: The method of Aspect 2, wherein the predicted random access failure is associated with a random access failure likelihood model.

Aspect 4: The method of Aspect 2, wherein the predicted random access failure is associated with one or more random access failure likelihood parameters.

Aspect 5: The method of Aspect 4, wherein the one or more random access failure likelihood parameters include a synchronization signal block (SSB) index.

Aspect 6: The method of Aspect 4, wherein the one or more random access failure likelihood parameters include a random access preamble index.

Aspect 7: The method of Aspect 4, wherein the one or more random access failure likelihood parameters include a random access occasion index.

Aspect 8: The method of Aspect 4, wherein the one or more random access failure likelihood parameters include a random access message transmit power.

Aspect 9: The method of Aspect 4, wherein the one or more random access failure likelihood parameters include a quantity of random access attempts relative to a random access attempt threshold.

Aspect 10: The method of Aspect 4, wherein the one or more random access failure likelihood parameters include a received signal strength associated with a serving cell of the UE.

Aspect 11: The method of Aspect 4, wherein the one or more random access failure likelihood parameters include one or more of a power class of the UE or a maximum transmit power of the UE.

Aspect 12: The method of Aspect 2, wherein deactivating the one or more SCells includes deactivating the one or more SCells in accordance with a likelihood of the predicted random access failure satisfying a random access failure likelihood threshold.

Aspect 13: The method of any of Aspects 1-12, wherein the random access failure comprises a deterministic random access failure.

Aspect 14: The method of Aspect 13, wherein the deterministic random access failure comprises a quantity of random access attempts satisfying a random access attempt threshold.

Aspect 15: The method of any of Aspects 1-14, wherein deactivating the one or more Scells includes deactivating the one or more Scells by a layer 1 (L1) controller of the UE responsive to the L1 controller obtaining an SCell failure status indication from a medium access control (MAC) controller of the UE.

Aspect 16: The method of Aspect 15, wherein deactivating the one or more Scells includes disabling, by the L1 controller, radio frequency (RF) hardware or firmware streaming on the one or more Scells.

Aspect 17: A method of wireless communication performed at a user equipment (UE), comprising: identifying one or more random access failure likelihood parameters; identifying, using a random access failure likelihood model and the one or more random access failure likelihood parameters, a likelihood of a predicted random access failure.

Aspect 18: The method of Aspect 17, wherein the one or more random access failure likelihood parameters include one or more of a synchronization signal block (SSB) index, a quantity of random access attempts relative to a random access attempt threshold, a received signal strength associated with a serving cell of the UE, a power class of the UE, or a maximum transmit power of the UE.

Aspect 19: The method of any of Aspects 17-18, wherein the one or more random access failure likelihood parameters include a random access preamble index.

Aspect 20: The method of any of Aspects 17-19, wherein the one or more random access failure likelihood parameters include a random access occasion index.

Aspect 21: The method of any of Aspects 17-20, wherein the one or more random access failure likelihood parameters include a random access message transmit power.

Aspect 22: The method of any of Aspects 17-21, further comprising: deactivating one or more SCells in accordance with the likelihood of the predicted random access failure.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a random access initiation message associated with one or more of a primary cell (PCell) of the UE or one or more secondary cells (SCells) of the UE; and
deactivate the one or more SCells responsive to a random access failure.

2. The apparatus of claim 1, wherein the random access failure comprises a predicted random access failure.

3. The apparatus of claim 2, wherein the predicted random access failure is associated with one or more of a random access failure likelihood model or one or more random access failure likelihood parameters.

4. The apparatus of claim 3, wherein the one or more random access failure likelihood parameters include one or more of a synchronization signal block (SSB) index, a random access preamble index, a random access occasion index, or a random access message transmit power.

5. The apparatus of claim 3, wherein the one or more random access failure likelihood parameters include a quantity of random access attempts relative to a random access attempt threshold.

6. The apparatus of claim 3, wherein the one or more random access failure likelihood parameters include a received signal strength associated with a serving cell of the UE.

7. The apparatus of claim 3, wherein the one or more random access failure likelihood parameters include one or more of a power class of the UE or a maximum transmit power of the UE.

8. The apparatus of claim 2, wherein the at least one processor, to cause the UE to deactivate the one or more SCells, is configured to cause the UE to deactivate the one or more SCells in accordance with a likelihood of the predicted random access failure satisfying a random access failure likelihood threshold.

9. The apparatus of claim 1, wherein the at least one processor, to cause the UE to deactivate the one or more SCells, is configured to cause a layer 1 (L1) controller of the UE to deactivate the one or more SCells responsive to the L1 controller obtaining an SCell failure status indication from a medium access control (MAC) controller of the UE.

10. The apparatus of claim 9, wherein the at least one processor, to cause the L1 controller to deactivate the one or more Scells, is configured to cause the L1 controller to disable radio frequency (RF) hardware or firmware streaming on the one or more Scells.

11. A method of wireless communication performed at a user equipment (UE), comprising:
receiving a random access initiation message associated with one or more of a primary cell (PCell) of the UE or one or more secondary cells (SCells) of the UE; and
deactivating the one or more SCells responsive to a random access failure.

12. The method of claim 11, wherein the random access failure comprises a deterministic random access failure.

13. The method of claim 12, wherein the deterministic random access failure comprises a quantity of random access attempts satisfying a random access attempt threshold.

14. The method of claim 11, wherein the random access failure comprises a predicted random access failure.

15. The method of claim 14, wherein the predicted random access failure is associated with a random access failure likelihood model or one or more random access failure likelihood parameters.

16. The method of claim 15, wherein the one or more random access failure likelihood parameters include one or more of a synchronization signal block (SSB) index, a random access preamble index, a random access occasion index, or a random access message transmit power.

17. A method of wireless communication performed at a user equipment (UE), comprising:
identifying one or more random access failure likelihood parameters; and
identifying, using a random access failure likelihood model and the one or more random access failure likelihood parameters, a likelihood of a predicted random access failure.

18. The method of claim 17, wherein the one or more random access failure likelihood parameters include one or more of a synchronization signal block (SSB) index, a quantity of random access attempts relative to a random access attempt threshold, a received signal strength associated with a serving cell of the UE, a power class of the UE, or a maximum transmit power of the UE.

19. The method of claim 17, wherein the one or more random access failure likelihood parameters include one or more of a random access preamble index, a random access occasion index, or a random access message transmit power.

20. The method of claim 17, further comprising:
deactivating one or more secondary cells (SCells) in accordance with the likelihood of the predicted random access failure.
